(19) United States
(12) Patent Application Publication
(10) Pub. No.: US 2024/0094997 A1
(43) Pub. Date: Mar. 21, 2024

(54) COMPILING QUANTUM COMPUTING PROGRAM SPECIFICATIONS BASED ON QUANTUM OPERATIONS

(71) Applicant: ColdQuanta, Inc., Boulder, CO (US)

(72) Inventor: Michael Alexandrovich Perlin, Chicago, IL (US)

(73) Assignee: ColdQuanta, Inc., Boulder, CO (US)

(21) Appl. No.: 18/199,075

(22) Filed: May 18, 2023

Related U.S. Application Data
(60) Provisional application No. 63/348,130, filed on Jun. 2, 2022.

(51) Int. Cl. G06F 8/41

(52) U.S. Cl. CPC G06F 8/41

(57) ABSTRACT

Compiling a program specification that comprises at least one quantum circuit associated with both a set of quantum operations and a first schedule for the set of quantum operations includes assigning each quantum operation in the set to a first passed set, a first caught set, or a first blocked set. The first blocked set includes a first quantum operation that addresses one or more qubits that are addressed by at least one quantum operation in the first caught set. A first passed set ordering is determined. A first caught set ordering is determined. Determining a second schedule for the set of quantum operations includes assigning the quantum operations in the first caught set to be performed after the quantum operations in the first passed set, and assigning the quantum operations in the first blocked set to be performed after the quantum operations in the first caught set.

### CROSS-REFERENCE TO RELATED APPLICATION(S)

This application claims priority to and the benefit of U.S. Patent Application Ser. No. 63/348,130, entitled “COMPILING QUANTUM COMPUTING PROGRAM SPECIFICATIONS BASED ON QUANTUM OPERATIONS,” filed on Jun. 2, 2022, incorporated by reference herein.

### STATEMENT AS TO FEDERALLY SPONSORED RESEARCH

This invention was made with government support under Contract No. DE-SC0021526 by the U.S. Department of Energy. The government has certain rights in the invention.

### TECHNICAL FIELD

This disclosure relates to compiling quantum computing program specifications based on quantum operations.

### BACKGROUND

A quantum computer can be used to perform classically challenging computational tasks. A quantum compiler is able to translate a desired computational task expressed in a higher-level program specification into a lower-level compiled specification that includes information (e.g., about particular quantum gates) that can be used to configure a particular type of quantum computer to perform the computational task, possibly in conjunction with a classical computer and classical operations.

### SUMMARY

In one aspect, in general, a method for compiling a program specification that comprises at least one quantum circuit associated with both a set of quantum operations and a first schedule for the set of quantum operations comprises: assigning each quantum operation in the set of quantum operations to a first passed set, a first caught set, or a first blocked set, based at least in part on one or more of the first schedule, types of the quantum operations, or qubits addressed by the quantum operations, wherein the first blocked set includes a first quantum operation that addresses one or more qubits that are addressed by at least one quantum operation in the first caught set; determining a first passed set ordering based at least in part on one or both of the first schedule or the qubits addressed by the quantum operations; determining a first caught set ordering based at least in part on one or both of the first schedule or the qubits addressed by the quantum operations; and determining a second schedule for the set of quantum operations, the determining comprising: assigning the quantum operations in the first caught set to be performed after the quantum operations in the first passed set, and assigning the quantum operations in the first blocked set to be performed after the quantum operations in the first caught set.

Aspects can include one or more of the following features.

The method further comprises assigning each quantum operation in the first blocked set to a second passed set, a second caught set, or a second blocked set, based at least in part on one or more of the first schedule, types of the quantum operations, or qubits addressed by the quantum operations, where the second blocked set includes at least one quantum operation that addresses one or more qubits that are addressed by at least one quantum operation in the second caught set.

The method further comprises determining a second passed set ordering based at least in part on one or both of the first schedule or the qubits addressed by the quantum operations, and determining a second caught set ordering based at least in part on one or both of the first schedule or the qubits addressed by the quantum operations.

Each quantum operation in the second caught set is a unitary single-qubit quantum operation.

Each quantum operation in the second passed set is a multi-qubit quantum operation that operates on two or more qubits.

The determining of the second schedule for the set of quantum operations further comprises: assigning the quantum operations in the second caught set to be performed after the quantum operations in the second passed set, and assigning the quantum operations in the second blocked set to be performed after the quantum operations in the second caught set.

The first blocked set comprises a plurality of quantum operations, and each remaining quantum operation other than the first quantum operation in the first blocked set addresses one or more qubits that are addressed by at least one quantum operation in the first caught set or the first blocked set other than that remaining quantum operation.

The method further comprises generating a first graph-based representation based at least in part on the program specification.

The first graph-based representation is a directed acyclic graph.

The method further comprises comprising generating respective graph-based representations for the first passed set, the first caught set, and the first blocked set.

The respective graph-based representation associated with the first caught set contains no edges.

Each quantum operation in the first caught set is a unitary single-qubit quantum operation.

Each quantum operation in the first passed set is a multi-qubit quantum operation that operates on two or more qubits.

The set of quantum operations comprises non-unitary quantum operations.

The quantum circuit is associated with binary information.

At least a portion of the binary information is associated with outcomes from qubit measurements.

One or more of the quantum operations in the set of quantum operations depends on the binary information.

The first caught set comprises one or more unitary single-qubit quantum operations that depend on the binary information.

The first passed set comprises one or more non-unitary quantum operations that depend on the binary information.

The at least one quantum circuit is associated with classical operations.

In another aspect, in general, a method for compiling a program specification comprises: receiving the program specification that includes at least one quantum circuit associated with a first set of quantum operations; and generating a compiled program specification, wherein the compiled program specification performs the same computational task as the received program specification, the generating comprising: calculating a respective set of quantum operations and a respective set of rotation angles for each quantum operation in the first set of quantum operations, and determining at least one global quantum operation and at least one inverse of the global quantum operation, wherein the calculating is based at least in part on the first set of quantum operations, the global quantum operation, and the inverse of the global operation.

Aspects can include one or more of the following features.

The determining further comprises: combining a first quantum operation and a second quantum operation in a second set of quantum operations within the set of quantum operations calculated for each quantum operation in the first set of quantum operations, the first quantum operation and the second quantum operation each comprising at least one angle of rotation about an axis common to the first and second quantum operations, into one or more quantum operations in a third set of quantum operations, the combining comprising geometrically adding the angles of rotation of the first and second quantum operations about the common axis to calculate a combined angle of rotation.

The third set of quantum operations contains fewer quantum operations than the second set of quantum operations.

At least one global quantum operation and at least one inverse of the global quantum operation are scheduled to execute between the execution of the first quantum operation and the second quantum operation in the second set of quantum operations.

A magnitude of an angle of rotation of the first global quantum operation is equal to half of an angle of rotation specified by a quantum operation in the received program specification.

The at least one quantum circuit is associated with a second set of quantum operations.

The method further comprises calculating a respective set of quantum operations and a respective set of rotation angles for each quantum operation in the second set of quantum operations.

The calculated set of quantum operations for each quantum operation in the second set of quantum operations comprises at least one of the quantum operations in the second set of quantum operations.

The calculated set of quantum operations for each quantum operation in the second set of quantum operations comprises a second global quantum operation and an inverse of the second global quantum operation.

The second global quantum operation and the inverse of the second global quantum operation each perform a quantum rotation with angles of rotation that are approximately equal in magnitude and that are each less than pi/2 radians in magnitude.

The calculated set of rotation angles for two or more of the quantum operations in the first set of quantum operations are calculated to reduce the total number of quantum operations performed.

The calculated set of rotation angles for two or more of the quantum operation in the first set of quantum operations are calculated to reduce the sum of the magnitudes of the rotations performed by the single-qubit quantum operations.

The at least one quantum circuit is associated with binary information.

At least a portion of the binary information is associated with outcomes from measurements of one or more qubits associated with the at least one quantum circuit.

One or more of the quantum operations in the first set of quantum operations depends on the binary information.

The at least one quantum circuit is associated with classical operations.

In another aspect, in general, a method for compiling a program specification comprises: receiving the program specification that includes at least one quantum circuit associated with a first set of quantum operations, the first set of quantum operations comprising a first quantum operation; and decomposing the first quantum operation into a second set of quantum operations, the second set of quantum operations comprising one or more single-qubit quantum operations, a first global quantum operation, and an inverse of the first global quantum operation; wherein the first global quantum operation and the inverse of the first global operation each perform a quantum rotation with angles of rotation that are approximately equal in magnitude and that are each less than pi/2 radians in magnitude.

Aspects can include one or more of the following features.

The magnitude of the angle of rotation of the first global quantum operation is equal to half of an angle of rotation specified by the first quantum operation.

A second quantum operation in the first set of quantum operations is decomposed into a third set of quantum operations, the third set of quantum operations comprising a second global quantum operation and an inverse of the second global quantum operation.

The second global quantum operation and the inverse of the second global quantum operation each perform a quantum rotation with angles of rotation that are approximately equal in magnitude and that are each less than pi/2 radians in magnitude.

The method further comprises choosing a set of angles used as parameters for the one or more single-qubit quantum operations.

The set of angles are chosen to reduce the total number of quantum operations performed.

The set of angles are chosen to reduce the sum of the magnitudes of the rotations performed by the single-qubit quantum operations.

The determining further comprises: combining a third quantum operation and a fourth quantum operation in a fourth set of quantum operations, the third quantum operation and the fourth quantum operation each comprising at least one angle of rotation about an axis common to the third and fourth quantum operations, into one or more quantum operations in a fifth set of quantum operations, the combining comprising geometrically adding the angles of rotation of the third and fourth quantum operations about the common axis to calculate a combined angle of rotation.

The fifth set of quantum operations contains fewer quantum operations than the fourth set of quantum operations.

At least one global quantum operation and at least one inverse of the global quantum operation are scheduled to execute between the execution of the third quantum operation and the fourth quantum operation.

The at least one quantum circuit is associated with binary information.

At least a portion of the binary information is associated with outcomes from qubit measurements.

One or more of the quantum operations in the first set of quantum operations depends on the binary information.

In another aspect, in general, a method for compiling a program specification that comprises at least one quantum circuit associated with both a first set of quantum operations and a first schedule for the first set of quantum operations comprises: assigning each quantum operation in the first set of quantum operations to either (1) one passed set from a set of one or more passed sets or (2) one caught set from a set of one or more caught sets, based at least in part on one or more of the first schedule, types of the quantum operations, or qubits addressed by the quantum operations; and decomposing two or more quantum operations in a first caught set of the one or more caught sets into a second set of quantum operations, the second set of quantum operations comprising one or more single-qubit quantum operations, a first global quantum operation, and an inverse of the first global quantum operation.

Aspects can include one or more of the following features.

The method further comprises, after the assigning, determining a second schedule for the first set of quantum operations.

Determining the second schedule comprises: determining a first passed set ordering based at least in part on one or both of the first schedule or the qubits addressed by the first set of quantum operations, and determining a first caught set ordering based at least in part on one or both of the first schedule or the qubits addressed by the first set of quantum operations.

Determining the second schedule comprises: assigning quantum operations in the first caught set to be performed after quantum operations in a first passed set, and assigning quantum operations in a second passed set to be performed after quantum operations in the first caught set.

Each quantum operation in the one or more caught sets is a single-qubit quantum operation.

Each quantum operation in the one or more passed sets is a multi-qubit quantum operation that operates on two or more qubits.

The method further comprises decomposing two or more quantum operations in a second caught set of the one or more caught sets into a third set of quantum operations, the third set of quantum operations comprising one or more single-qubit quantum operations, a second global quantum operation, and an inverse of the second global quantum operation.

The method further comprises determining a third schedule comprising the first set of quantum operations, the second set of quantum operations, and the third set of quantum operations, excluding quantum operations that were decomposed into the second set of quantum operations or that were decomposed into the third set of quantum operations.

The method further comprises generating a first graph-based representation based at least in part on the program specification.

The first graph-based representation is a directed acyclic graph.

The method further comprises generating respective graph-based representations for at least one of the one or more passed sets and at least one of the one or more caught sets.

The respective graph-based representation associated at least one of the one or more caught sets contains no edges.

The first set of quantum operations comprises non-unitary quantum operations.

The at least one quantum circuit is associated with binary information.

At least a portion of the binary information is associated with outcomes from qubit measurements.

One or more of the quantum operations in the first set of quantum operations depends on the binary information.

At least of the one or more caught sets comprise one or more unitary single-qubit quantum operations that depend on the binary information.

The at least one of the one or more passed sets comprise one or more non-unitary quantum operations that depend on the binary information.

The at least one quantum circuit is associated with classical operations.

In another aspect, in general, an apparatus for compiling a program specification comprises: a digital computer comprising at least one central processing unit, the digital computer configured to: process information based on at least one quantum circuit associated with both a first set of quantum operations and a first schedule for the first set of quantum operations, and provide a compiled quantum program; memory storing the compiled quantum program; a quantum computer comprising a plurality of quantum processing elements associated with respective quantum states, and configured to apply coupling and transformation operations to a plurality of the quantum states according to the compiled quantum program; where the processing comprises: assigning each quantum operation in the first set of quantum operations to either (1) one passed set from a set of one or more passed sets or (2) one caught set from a set of one or more caught sets, based at least in part on one or more of the first schedule, types of the quantum operations, or qubits addressed by the quantum operations, and decomposing two or more quantum operations in a first caught set of the one or more caught sets into a second set of quantum operations, the second set of quantum operations comprising one or more single-qubit quantum operations, a first global quantum operation, and an inverse of the first global quantum operation.

Aspects can include one or more of the following features.

Each quantum operation in the caught sets is a unitary single-qubit quantum operation.

Each quantum operation in the passed sets is a multi-qubit quantum operation that operates on two or more qubits.

The plurality of quantum processing elements are neutral atoms or trapped ions.

The quantum computer further comprises a microwave source configured to perform the first global quantum operation and the inverse of the first global quantum operation.

The quantum computer further comprises a laser source configured to perform the one or more single-qubit quantum operations.

The first global quantum operation and the inverse of the first global operation each perform a quantum rotation with angles of rotation that are approximately equal in magnitude and that are each less than pi/2 radians in magnitude.

The quantum circuit is associated with classical operations.

Aspects can have one or more of the following advantages.

Some implementations of the techniques described herein are able to compile a program specification in a manner that avoids certain experimentally intractable quantum operations in an efficient manner. For example, to avoid a particular type of experimentally intractable quantum operation, one or more translated quantum operations can be performed that would yield an equivalent result. If some of the translated quantum operations would be computationally expensive to perform, techniques can be used to reduce the number of the computationally expensive quantum operations in the compiled specification, as described in more detail below.

Other features and advantages will become apparent from the following description, and from the figures and claims.

### BRIEF DESCRIPTION OF THE DRAWINGS

The disclosure is best understood from the following detailed description when read in conjunction with the accompanying drawing. It is emphasized that, according to common practice, the various features of the drawing are not to-scale. On the contrary, the dimensions of the various features are arbitrarily expanded or reduced for clarity.

FIG. 1 is a schematic diagram of an example quantum computing system.

FIG. 2 is a schematic diagram of an example Bloch sphere.

FIG. 3A is a schematic diagram of an example circuit.

FIG. 3B is a schematic diagram of an example directed acyclic graph corresponding to the example circuit in FIG. 3A.

FIG. 4A is a coding description of an example sifting algorithm.

FIG. 4B is a flowchart of an example sifting algorithm.

FIG. 5A is a coding description of an example scheduling algorithm.

FIG. 5B is a flowchart of an example scheduling algorithm.

FIG. 6A is a schematic diagram of an example circuit.

FIG. 6B is a schematic diagram of the example circuit in FIG. 6A after being sifted once.

FIG. 6C is a schematic diagram of the example circuit in FIG. 6A after being sifted repeatedly.

FIG. 6D is a schematic diagram of an example schedule for the example circuit in FIG. 6A.

FIG. 7A is a schematic diagram of an example circuit.

FIG. 7B is a schematic diagram of the example circuit in FIG. 7A after being pre-compiled.

FIG. 7C is a schematic diagram of an example directed acyclic graph corresponding to the example pre-compiled circuit in FIG. 7B.

FIG. 7D is a schematic diagram of the example directed acyclic graph in FIG. 7C after being sifted.

FIG. 7E is a schematic diagram of an example schedule for the example directed acyclic graph in FIG. 7D.

FIG. 7F is a schematic diagram of an example scheduled circuit corresponding to the example schedule in FIG. 7E.

FIG. 8 is a schematic diagram of an example decomposition of a quantum rotation on the Bloch sphere.

FIG. 9 is a schematic diagram of an example decomposition of a quantum rotation on the Bloch sphere.

FIG. 10A is a schematic diagram of an example quantum gate backlog.

FIG. 10B is a schematic diagram of an example quantum gate backlog.

FIG. 11 shows a flowchart of a procedure for compiling a program specification.

FIG. 12 shows a flowchart of a procedure for compiling a program specification.

FIG. 13 shows a flowchart of a procedure for compiling a program specification.

FIG. 14 shows a flowchart of a procedure for compiling a program specification.

### DETAILED DESCRIPTION

While a classical computer operates on binary information (e.g., in terms of classical bits represented as having a value of 0 or 1, or any equivalent representation of binary information, such as hexadecimal), a quantum computer operates on quantum bits, also called “qubits”. Qubits may be composed of a weighted combination of two quantum states that are used as basis states, often labelled |0 [symbol] and |1 [symbol] . In general, more than two quantum states may be used, which can result in information often termed “qudits”. Herein qubits are used for explanation purposes, though the examples may also apply to qudits. The quantum nature of qubits allows one to utilize quantum properties such as superposition, entanglement, and interference to perform computations.

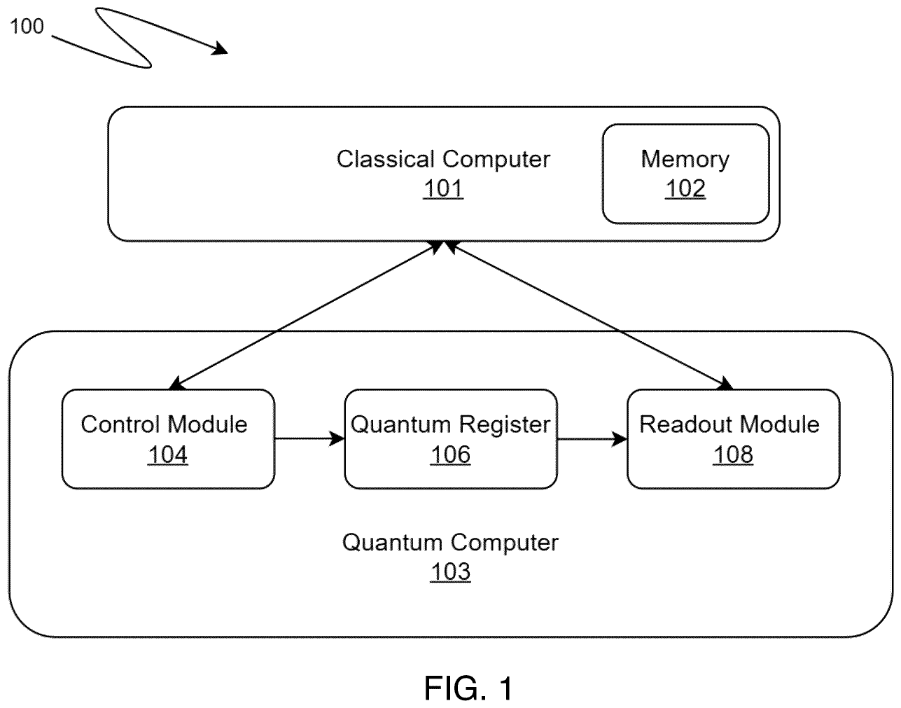

FIG. 1 shows an example of a quantum computing system 100. The quantum computing system 100 includes a classical computer 101 that is configured to communicate with a quantum computer 103. The classical computer 101 includes a memory 102 that acts as a storage medium and may store information related to the classical computer 101 and the quantum computer 103. For example, the memory 102 may store a compiled program specification specifying a schedule for a set of quantum operations. The quantum computer 103 includes a control module 104, a quantum register 106, and a readout module 108. The control module 104 is able to produce analog and/or digital signals that may then be utilized by the quantum computer 103 to perform quantum operations. The design and capabilities of the control module 104 may vary depending on the computational task or the quantum register 106. The quantum register 106 stores quantum states representing qubits. The quantum state(s) of one or more physical storage elements of the quantum register 106 (e.g., circuits, atoms, ions, photons) can be used to represent a given qubit that will be used in a quantum computation (also called a computational qubit). In some implementations, error correction may be used to provide qubits that have reduced susceptibility to various kinds of errors. The quantum register 106 comprises a plurality of quantum processing elements associated with respective quantum states. The control module 104 performs quantum operations on the qubits by applying coupling and transformation operations to a plurality of the quantum states according to a compiled quantum program. The quantum computer 103 may include subsystems for the generation of radio-frequency (RF) pulses, microwave pulses, or laser pulses, for example, in response to signals from the control module 104, designed to perform quantum operations. The quantum computer 103 may perform quantum operations in a specific sequence or within certain timing and synchronization constraints. For example, depending on the duration of an RF pulse applied to a qubit, the pulse may create a qubit corresponding to a superposition of the two quantum states (i.e., a weighted sum of the quantum states where the weights are complex numbers), or may convert one qubit value to another qubit value, such as converting |0 [symbol] to |1 [symbol] .

Referring to FIG. 1, the readout module 108 in communication with the classical computer 101 is configured to convert the quantum state(s) of one or more of the qubits of the quantum register 106 into information that may then be sent to the classical computer 101. In some implementations, the readout module 108 includes measurement devices (not shown) that measure qubits that each may be found to be in a particular one of two possible basis states of the measurement device (which may correspond to the states |0 [symbol] to |1 [symbol] , or other orthogonal basis states). For example, the readout module 108 may include lasers and imaging devices that perform fluorescence imaging. In one example of fluorescence imaging, each atom in measured to be in the state |0 [symbol] would appear bright, while atoms measured to be in the state |1 [symbol] would appear dark. A quantum circuit that includes a series of quantum gates performing quantum operations on a number of qubits in a quantum register will typically also include measurement operations. A given quantum circuit may specify that qubits are to be measured at the end of the quantum circuit, and/or within the quantum circuit (i.e., for mid-circuit measurement). Some measurements may “collapse” the state of a qubit to a particular basis state, or may leave the qubit in a state that is not fully collapsed (e.g., for a quantum nondemolition measurement). The classical computer 101 may use the information from the readout module 108 to perform further quantum computation using the quantum computer 103, or to provide information to a classical algorithm, to a different computing system, and/or to a user of the quantum computing system 100.

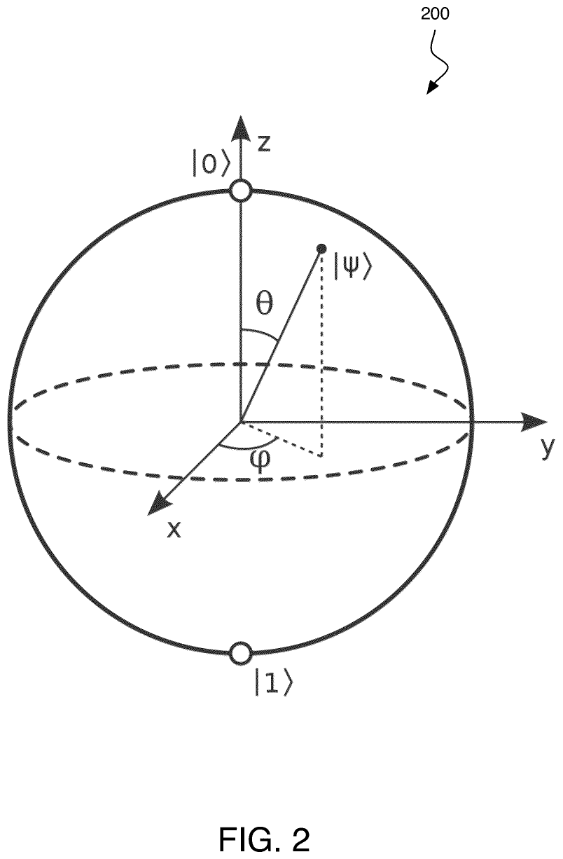

FIG. 2 shows an example Bloch sphere 200. The Bloch sphere 200 may be a useful pictorial representation of a quantum state corresponding to a portion of a quantum system. When a single qubit is in a pure state, it can be represented by a point on the surface of the Bloch sphere 200. When a single qubit is in a mixed state, it can be represented by a point on the interior of the Bloch sphere 200. A pure state is a quantum state that can be represented by a single vector in the Hilbert space, while a mixed state is a quantum state that is composed from a mixture of pure states. Mixed states can result from incomplete information about the preparation of the quantum state, or from entanglement with a quantum state of another system. Due to certain constraints (e.g., normalization), a given pure state can be represented by fewer degrees of freedom than the the four real numbers that specify the values of the two complex numbers that are the weights of the two basis states in a superposition of those basis states. In this example, those degrees of freedom correspond to the surface of the Bloch sphere, but other examples are possible.

Referring to FIG. 2, one example of a quantum operation is to “rotate” the quantum state about an axis of the Bloch sphere 200. The rotation can transform the quantum state into a new state, and the visual representation provided by the Bloch sphere 200 can make the quantum transformations easier to interpret. In addition to the visual representation provided by the Bloch sphere 200, both pure and mixed quantum states can be mathematically described by a density operator, ρ, also known as a density matrix.

There are various kinds of physical systems that can allow for quantum computation, including trapped ions, superconducting circuits, neutral atoms, NV-centers, and photonics. Trapped ion quantum computing can utilize electromagnetic fields to trap charged atomic particles-ions. Neutral atom quantum computing can utilize an array of laser light to trap cold atoms. In both trapped ions and neutral atoms, the energy levels of the ions or atoms may be used as quantum states for quantum computation. Once the ions or atoms are confined, two of their energy levels can be coupled (e.g., via laser light and/or microwaves), thus allowing one to perform a set of quantum operations. In some example trapped ion systems, the motion of the ions may be altered by laser light, and through the Coulomb force, one may quantum mechanically entangle two or more ions. In some example neutral atom systems, a Rydberg blockade may allow for quantum mechanical entanglement across two or more atoms. Some physical systems may allow for the representation of quantum states based on more than two basis states, which can be referred to as quantum digits, also called “qudits.” The techniques described herein with respect to quantum states expressed in qubits can also be implemented using quantum states expressed in qudits.

Both trapped ion and neutral atom quantum computing platforms can store the ions or atoms in a vacuum chamber, thus preventing collisions with background atmospheric gases that would lead to heating. Superconducting circuits, on the other hand, may be stored in a cryogenic environment, such as a dilution refrigerator.

The quantum operations that a quantum computer can perform may be limited by experimental factors. For instance, for some neutral atom quantum computing platforms (also called cold atom quantum computing platforms), it may be experimentally challenging to rotate a single qubit state about the y-axis of the Bloch sphere. Experimentally, it may be simpler to perform global operations on many qubits, rotating each qubit around the y-axis of its respective Bloch sphere. The inverse of the global operation can be applied to return the many qubits to their original locations on their respective Bloch spheres. However, in some examples it may be beneficial to perform a net rotation on a single qubit by performing an experimentally simpler rotation such (e.g., a rotation about the z-axis) on that single qubit between a global operation and an inverse of the global operation. Then, the sequence of operations would be: a global operation, followed by a single-qubit rotation, followed by an inverse of the global operation. Thus, at the end of the sequence of operations, the single qubit is rotated about an axis with respect to its original position while the other qubits are unchanged.

The above approach is able to circumvent the experimental intractability of performing a rotation about some axis by instead performing global rotations that apply to all qubits, as well as a single-qubit rotation that may be experimentally simpler. For example, some quantum operations may be implemented using laser pulses that can address specific target atoms, while other gates may be implemented using microwave fields, generated via one or more microwave sources, that uniformly address all or many qubits in a given device.

The next goal is to then minimize and/or reduce the total number of global operations, which can be computationally expensive and/or noisy. Rather than addressing only a single qubit between the two global operations, the methods disclosed herein find quantum operations that can be grouped together, such that if they are individually rotated in a certain manner, then the global operations will perform the desired net rotation on the grouped qubits. Such a method reduces the number of global operations that must be performed while achieving the same end result of the desired quantum operation.

An additional method to reduce the number of quantum operations for a given task may include using a quantum gate backlog. A quantum gate backlog can reduce the number of quantum operations by keeping track of the quantum rotations for one or more qubits. For example, the backlog may keep track of Rz gates that need to be applied to each qubit, and can be used to combine these gates and apply them later in the computation. For example, instead of performing two separate quantum rotations about the same axis (e.g., 30 degrees and 40 degrees), the quantum gate backlog keeps track of the rotations and combines them (e.g., 70 degrees), thus reducing the number of quantum rotations performed.

The following definitions are provided for describing some example implementations of the techniques disclosed herein.

A “directed graph” G=(V, E) consists of a set of vertices, V, and a set of edges, E, for which each edge e∈E is an ordered pair of vertices in V, which is to say e=(v, w) for some v, w∈V.

Given a directed graph G=(V, E), a “path” from vertex v∈V to vertex w∈V is a sequence of N edges, (e₁, e₂, . . . , e_{N}) with each eⱼ=(aⱼ, bⱼ)∈E, in which (1) the path starts at v, which is to say that a₁=v, (2) the path ends at w, which is to say that b_{N}=w, (3) consecutive edges are connected by a vertex, which is to say that bⱼ=aⱼ₊₁. The length of a path, N, may generally be any positive integer.

Given a directed graph G=(V, E), the vertex v∈V is a “predecessor” of vertex w∈V if and only if there exists a path from v to w. In this case, w is said to be a “successor” of v.

A “source” in a graph G=(V, E) is a vertex v∈V that has no predecessors. A “sink” in G is a vertex w∈V with no successors.

A “cycle” is a path that starts and ends at the same vertex. A “directed acyclic graph” is a directed graph that contains no cycles.

A “topological ordering” T of a directed acyclic graph G=(V, E) is a sequence of all vertices in V, which is to say T=(v₁, v₂, . . . , v_{|V|}), in which vertex vₐ precedes vertex v_{b} in the sequence T if (vₐ, v_{b})∈E. Here |V| is the number of vertices in V. Every directed acyclic graph has at least one topological ordering.

A “circuit” is a directed acyclic graph C=(V, E) that represents instructions by which a computer performs a specific computation. The computer in question may generally contain both classical and quantum elements. The vertices in V are in one-to-one correspondence with logical operations that the computer must perform, so we may unambiguously refer to any vertex v∈V as an “operation”. An edge (v, w)∈E corresponds to one or more classical or quantum bits that are addressed consecutively by operations v and w. For any circuit C=(V, E), we may say that x∈C to mean that either x∈V or x∈E.

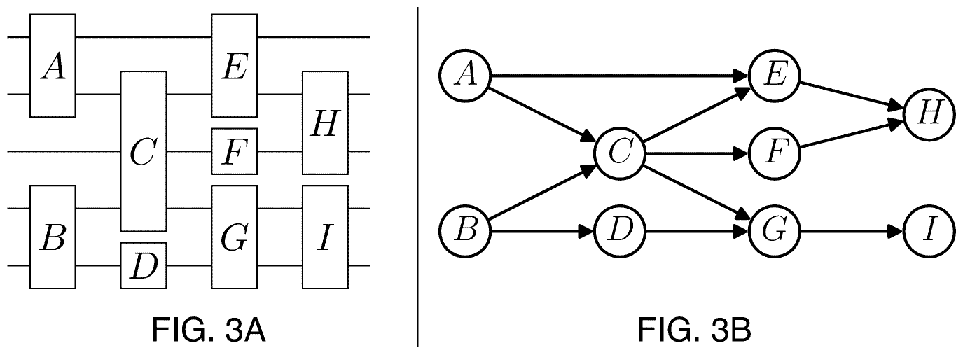

FIG. 3A shows an example circuit and FIG. 3B shows its representation as a directed acyclic graph. The circuit acts on five bits, with operations labeled from A through I.

A “quantum circuit” is a circuit comprising one or more quantum operations that address one or more quantum bits, and may further comprise any number of classical operations that address any number of classical bits. In some implementations, the quantum circuit can include quantum-classical hybrid operations which address both quantum and classical bits.

For any circuit C=(V, E) and vertex v∈V, we define “bits(v)” to be the set of bits (which may be classical or quantum) addressed by the operation associated with v. We then define “bits(C)” and “bits(V)” to be the set of all bits associated with operations in V, which is to say that bits(C)=bits(V)=∪_{v∈V} bits(v).

Any ordered pair of circuits (C₁, C₂), with each Cⱼ=(Vⱼ, Eⱼ), may be “concatenated” to construct a new circuit concat(C₁, C₂)=C_{concat}=(V_{concat}, E_{concat}). This concatenation is defined by:
1. V_{concat}=V₁ ∪V₂,
2. E_{concat}=E₁ ∪E₂ ∪E₁₂,
3. E₁₂ is the set of all edges (v₁, v₂) with v₁ ∈V₁ and v₂ ∈V₂ for which there exists at least one bit b addressed by both v₁ and v₂, i.e. b∈bits(v₁)∩bits(v₂), that is:
   (a) not addressed by any successor of v₁ in C₁,
   (b) not addressed by any predecessor of v₂ in C₂.
      The concatenation of a sequence (C₁, C₂, C₃, . . . ) of three or more circuits is defined inductively by concat(C₁, C₂, C₃, . . . )=concat(concat(C₁, C₂), C₃, . . . ).

A “quantum channel” is a mathematical object that uniquely represents the effect of a logical operation on a system. The system in question may generally contain both classical and quantum elements. Specifically, a quantum channel [symbol] _{O} representing a logical operation O is a map that takes any state ρᵢₙₚᵤₜ of a system, and returns the state ρₒᵤₜₚᵤₜ^{O} that is acquired by applying the logical operation O to the state ρᵢₙₚᵤₜ, which is to say that [symbol] _{O}(ρᵢₙₚᵤₜ)=ρₒᵤₜₚᵤₜ^{O}. The quantum channel of a circuit C=(V, E) can be acquired by composing the quantum channels of its operations in any topological order, which is to say that [symbol] _{C}(ρ)=ᵥ_{_{|V|}}( . . . [symbol] ᵥ_{₂}( [symbol] ᵥ_{₁}(ρ)) . . . ), where T=(v₁, v₂, . . . , v_{|V|}) is any topological ordering of C.

We say that circuits C₁ and C₂ are “equivalent” to mean that the quantum channel representing the action of C₁ on bits(C₁)∪bits(C₂) is equal to the quantum channel representing the action of C₂ on the same bits.

Here we define two sets of gates that play a role in some of the example compiler techniques described below.

Given an arbitrary quantum circuit, an existing compiler can be used to decompose the quantum circuit into an equivalent quantum circuit that contains only the following logical operations:
1. Two-qubit PartialCZ(α; j, k) gates of the form e^{-iα|11} [symbol] ^{11|}^{ⱼₖ}, where
   (a) α is any real number,
   (b) |11 [symbol] 11|ⱼₖ projects qubits j and k onto the state |1 [symbol] .
2. Single-qubit U3(θ, ϕ, λ; j) gates of the form e^{-iϕZ}^{ⱼ}^{/2}e^{-iθZ}^{ⱼ}^{/2}e^{-iλZ}^{ⱼ}^{/2}, where
   (a) θ, ϕ, and λ are any real numbers,
   (b) Zⱼ is a Pauli-Z operator for qubit j,
   (c) Yⱼ is a Pauli-Y operator for qubit j.
      We will refer to the set of all such logical operations as the “Standard CZ Gate Set”.

The compiling techniques described herein can be applied to any of a variety of types of quantum computing devices. In some of the examples described below, the quantum computing device is able to perform the following primitive logical operations:
1. Two-qubit PartialCZ(α; j, k) gates of the form e^{-iα|11} [symbol] ^{11|}^{ⱼₖ}, where
   (a) α is any real number,
   (b) |11 [symbol] 11|ⱼₖ projects qubits j and k onto the |1 [symbol] state.
2. Single-qubit Rz(η; j) gates of the form e^{-iηZ}^{ⱼ}^{/2}, where
   (a) η is any real number,
   (b) Zⱼ is a Pauli-Z operator for qubit j.
3. GlobalR(θ, ϕ) gates of the form e^{-iθX̅}^{_{ϕ}}^{/2}, where
   (a) θ and ϕ are any real numbers,
   (b) X̅_{ϕ}=cos ϕX̅+sin ϕY̅,
   (c) X̅=ΣⱼXⱼ, with Xⱼ a Pauli-X operator for qubit j,
   (d) Y̅=Σⱼ Yⱼ, with Yⱼ a Pauli-Y operator for qubit j,
   (e) the sum over j in X̅ and Y̅ is performed over all qubits in a quantum computing device.

We will refer to the set of all such operations as the “Cold Atom Gate Set” due to its current use in cold atom quantum computing devices, wherein “PartialCZ” gates and “Rz” gates may be implemented using laser pulses that can address specific target atoms, and “GlobalR” gates may be implemented using microwave fields that uniformly address all qubits in a given device. It is emphasized that, in general, the examples provided are hardware-agnostic and apply to systems other than cold atom quantum computing devices.

Given an arbitrary quantum circuit, an example compiler configured to perform the techniques described herein is able to construct an equivalent quantum circuit in which all unitary operations are in the Cold Atom Gate Set. On a high level, an example compiler method includes three stages:
1. “Pre-compile” an input circuit C_{orig} by converting it into an equivalent circuit C_{orig}^{CZ} in which all unitary operations are in the Standard CZ Gate Set. Pre-compiling may be done with existing methods.
2. “Schedule” the operations in the pre-compiled circuit C_{orig}^{CZ}, which is to say that we assign each operation v in the circuit C_{orig}^{CZ} a nonnegative integer S(v). We may refer to S(v) as the “moment” in which v occurs, and may additionally say that moment m “contains” the operation v if S(v)=m. Any given moment may contain multiple operations.
3. “Decompose” the circuit C_{orig}^{CZ}, assigning each moment m a circuit Cₘ whose unitary operations are in the Cold Atom Gate Set, and then using the circuits {Cₘ} to build a final circuit C_{final} that is equivalent to the original circuit C_{orig}.

Let C=(V, E) be a circuit. A “schedule” for C is a map S: V→ [symbol] from the set of vertices V to the set of nonnegative integers N. Before describing an example method for constructing a schedule, we define a procedure that we call “sifting”.

At a high-level, sifting through a circuit collects together a set of operations (with a specified type) that can be applied simultaneously or consecutively (in any order) without changing the circuit's topology. Specifically, sifting through a circuit C=(V, E) is a procedure defined by a boolean indicator function ƒ: V→{0, 1}, yielding three subcircuits of C:
1. A circuit C_{passed}=(V_{passed}, E_{passed}) that “passed through the sifter”.
2. A circuit C_{caught}=(V_{caught}, E_{caught}) that was “caught by the sifter”.
3. A circuit C_{blocked}=(V_{blocked}, E_{blocked}) of everything else (i.e., the remaining operations).
   We may refer to the triplet (C_{passed}, C_{caught}, C_{blocked}) as a “tripartition” of C, and suppress its implicit dependence on ƒ for brevity. This tripartition satisfies the following properties:
1. C_{passed}, C_{caught}, and C_{blocked} are mutually disjoint subgraphs of C whose union contains all operations in V.
2. ƒ(v)=0 for all operations v∈V_{passed}.
3. ƒ(v)=1 for all operations v∈V_{caught}.
4. w∈V_{blocked} if and only if w is a successor in C of some operation v∈V_{caught}.

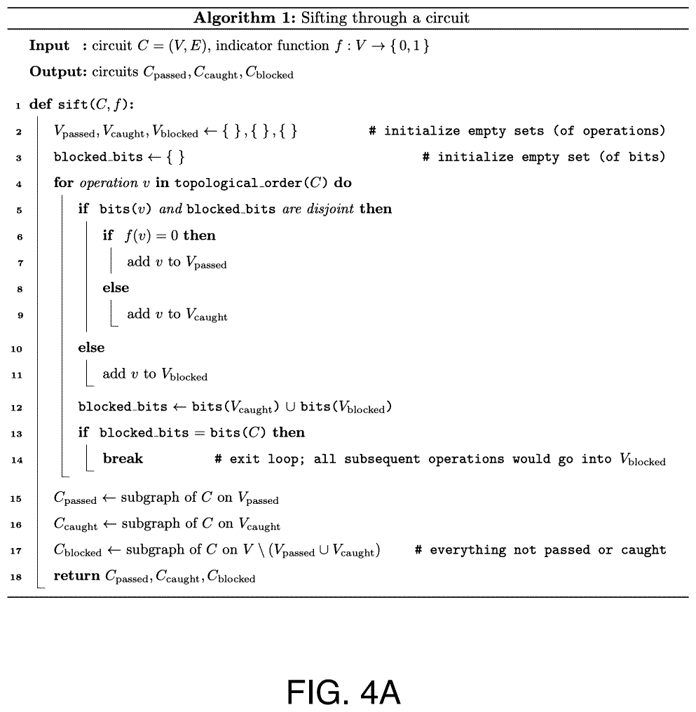

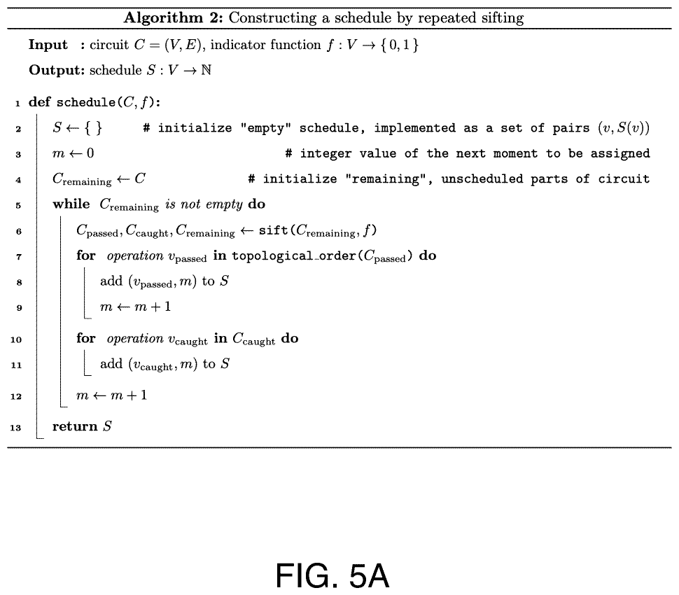

FIG. 4A shows a coding description of an example algorithm to construct the tripartition (C_{passed}, C_{caught}, C_{blocked}) from the circuit C with the indicator function ƒ. FIG. 6B shows the example algorithm of FIG. 4A applied to an example circuit FIG. 6A.

FIG. 4B shows a flowchart of an example sifting algorithm 400 for a circuit. First, the sifting algorithm 400 topologically sorts (402) the quantum operations in the circuit. Then the sifting algorithm 400 retrieves (404) a quantum operation, and checks (406) if the quantum operation is disjoint with previous quantum operations added to a caught set or a blocked set, both of which may be initially empty. If the quantum operation is not disjoint, the sifting algorithm 400 adds (410) the quantum operation to the blocked set. If the quantum operation is disjoint, the sifting algorithm 400 checks (408) if the quantum operation should be added to a passed set. The check (408) may comprise checking whether the quantum operation is a single-qubit quantum operation or a multi-qubit quantum operation. If the quantum operation passes the check (408), the sifting algorithm 400 adds (412) the quantum operation to the passed set. If the quantum operation does not pass the check (408), the sifting algorithm 400 adds (414) the quantum operation to the caught set. After performing either (410), (412), or (414), the sifting algorithm 400 checks (416) if there are remaining unclassified quantum operations in the circuit. If there are remaining unclassified quantum operations, the sifting algorithm 400 retrieves (404) another quantum operation from the set of remaining unclassified quantum operations. If there are not remaining unclassified quantum operations, the sifting algorithm 400 returns (418) each of the passed, caught, and remaining sets of quantum operations (i.e., sub-circuits).

Without intending to be bound by theory, for some examples, let C_{orig}^{CZ} be an arbitrary circuit whose unitary operations are in the Standard CZ Gate Set, and let ƒ_{SQG}: V_{orig}→{0, 1} be an indicator function that identifies single-qubit gates: ƒ_{SQG}(v)=1 if and only if the operation v addresses exactly one qubit. Loosely speaking, we can construct a schedule S: V_{orig}→ [symbol] for C_{orig}^{CZ} by repeatedly sifting through C_{orig}^{CZ}. After each sifting step, every operation that passed through the sifter gets assigned a unique moment, while the operations that were caught by the sifter get assigned to the same moment.

More specifically, we first define C_{blocked}⁽⁰⁾=C_{orig}^{CZ}. We then inductively define C_{passed}^{(j)}, C_{caught}^{(j)}, C_{blocked}^{(j)} for all positive integers j by defining Pⱼ=(C_{passed}^{(j)}, C_{caught}^{(j)}, C_{blocked}^{(j)}) to be the tripartition acquired by sifting through C_{caught}^{(j-1)}. In other words, Pⱼ is the tripartition acquired by sifting through C_{orig}^{CZ} a total of j times, each time setting aside everything that passed through or was caught by the sifter. We can “assign a moment” to a set of operations V⊂V_{orig} by picking the smallest moment m that has not yet been assigned, and defining S(v)=m for all v∈V. In this way, we iterate over all integers j from 1 to J_{final}, where J_{final} is the smallest positive integer k for which C_{blocked}^{(k)} is empty. For each j, we:
1. Iterate over all operations in C_{passed}^{(j)} in any topological order, and assign each operation a unique moment.
2. Assign all operations in C_{caught}^{(j)} to the same moment.

After constructing a schedule S for a circuit C, we may for brevity refer to the moments in the image of S that contain at least one operation as the moments of C.

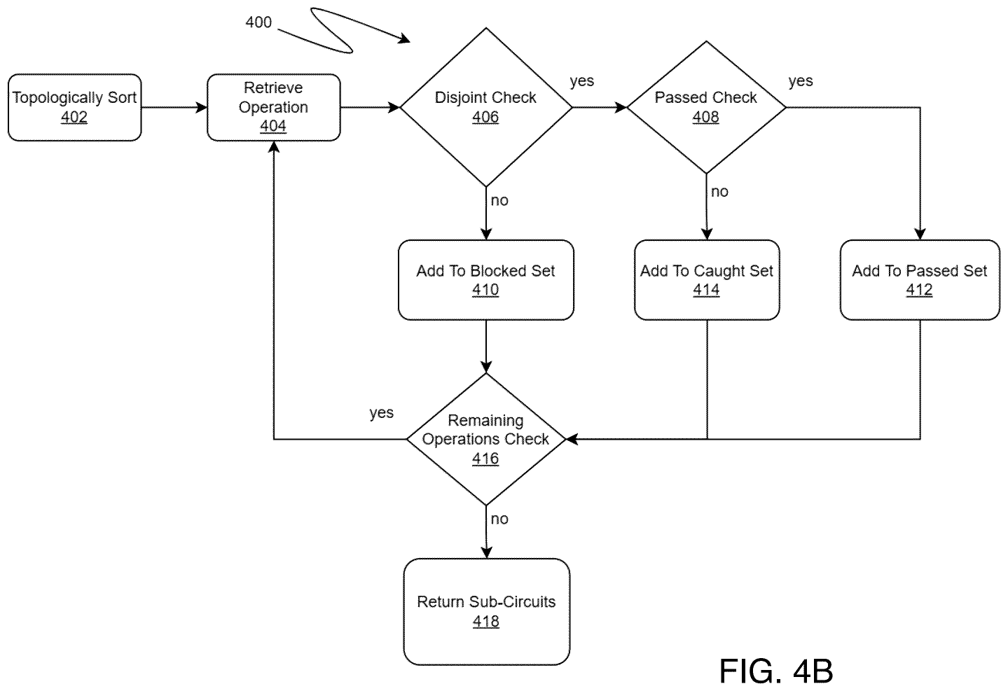

FIG. 5A shows a coding description of an example algorithm to construct a schedule for a circuit C with an indicator function ƒ.

FIG. 5B shows a flowchart of an example scheduling algorithm 500 for a circuit. First, the scheduling algorithm 500 initializes (502) an empty schedule and sifts the circuit (e.g., as described in FIGS. 4A and 4B), assigning each quantum operation to a passed set, a caught set, or a blocked set. Then the scheduling algorithm 500 checks (504) if there are quantum operations in the blocked set. If there are quantum operations in the blocked set, the scheduling algorithm 500 assigns (506) each quantum operation in the passed set its own new moment. Next, the scheduling algorithm 500 assigns (508) each quantum operation in the caught set to a new common moment shared between each quantum operation currently in the caught set. The common moment differs from the moments assigned in (506) to each of the quantum operations in the passed set. Next, the scheduling algorithm 500 sifts (510) through the quantum operations in the blocked set to obtain new passed, caught, and blocked sets. Then the scheduling algorithm 500 checks (504) if there are quantum operations in the blocked set. If there are not quantum operations in the blocked set, the scheduling algorithm terminates and returns (512) a schedule.

FIGS. 6A, 6B, 6C, and 6D show an example of scheduling. FIG. 6A shows the example circuit C=(V, E) with vertices labeled according to a topological order. Each vertex is colored grey if and only if ƒ(v)=1 for some fixed indicator function ƒ: V→{0, 1}. FIG. 6B shows the tripartition acquired by sifting through C once. Edges that cross partitions are eliminated by sifting, and are shown with dashed arrows. These edges can be recovered by concatenating the partitions. FIG. 6C shows the circuits acquired by repeated sifting. FIG. 6D shows a representation of the schedule constructed for C by repeated sifting. Referring to FIG. 6D, each column corresponds to a single moment, and moments increase from left to right.

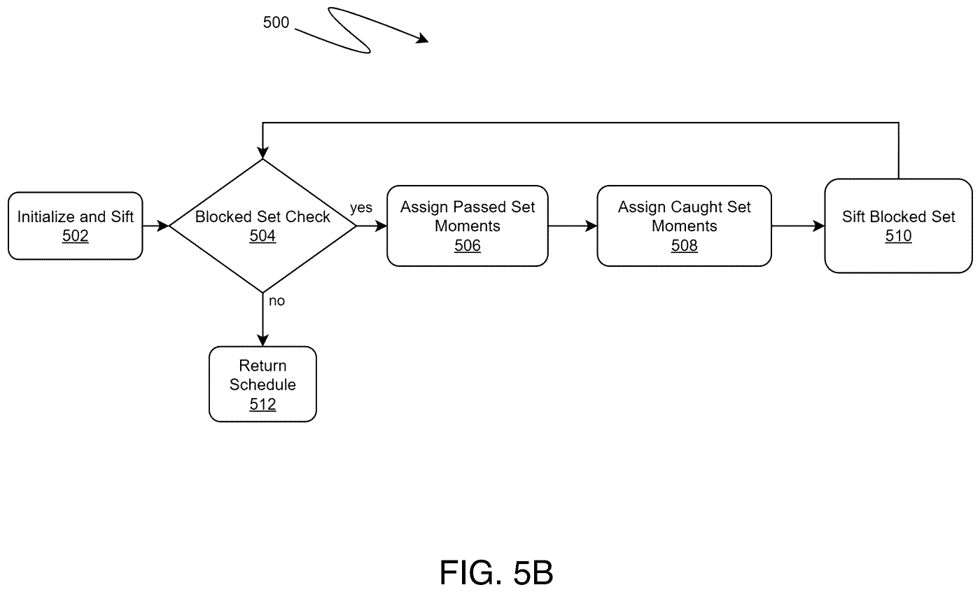

FIGS. 7A, 7B, 7C, 7D, 7E, and 7F show an example for the pre-compiling, sifting, and scheduling of a GHZ circuit that converts the state |0000 [symbol] into the GHZ state |0000 [symbol] +|1111 [symbol] (up to normalization factors). FIG. 7A shows an example GHZ circuit that converts the state |0000 [symbol] into |0000 [symbol] +|1111 [symbol] , expressed using a single Hadamard gate and three CNOT gates. FIG. 7B shows an example of a GHZ circuit pre-compiled into operations in the StandardCZGateSet. FIG. 7C shows an example pre-compiled GHZ circuit represented by a directed acyclic graph C=(V, E), corresponding to the pre-compiled GHZ circuit in FIG. 7B. FIG. 7D shows partitions acquired by repeated sifting of C. FIG. 7E shows an example schedule for C, constructed by repeated sifting. FIG. 7F shows an example of the scheduled circuit corresponding to the schedule for C in FIG. 7E.

After scheduling a pre-compiled circuit C_{orig}^{CZ} with an indicator function (e.g., ƒ_{SQG}) we may iterate over all moments of C_{orig}^{CZ}, and associate each moment m with a circuit Cₘ whose unitary operations are in the Cold Atom Gate Set. We refer to the procedure of constructing an initial circuit Cₘ that is associated with the moment m as “decomposing the moment” m. After decomposing all moments of C_{orig}^{CZ}, we may use the associated circuits to construct a final circuit C_{final} that is equivalent to C_{orig}^{CZ}, and therefore also equivalent to C_{orig}. Here, equivalent refers to the fact that the end result of two quantum circuits are the same, although the operations within each circuit may be different. We refer to the overall procedure of constructing the final circuit C_{final} from the scheduled circuit C_{orig}^{CZ} as “decomposing the circuit” C_{orig}^{CZ}.

If every operation v contained in a moment m addresses exactly one qubit, which is to say that ƒ_{SQG}(v)=1, then we call the moment m a “single-qubit gate moment”, or “SQGM”. Otherwise, we refer to m as a “multi-qubit gate moment”, or “MQGM”. Due to the method used for scheduling C_{orig}^{CZ}, every MQGM of C_{orig}^{CZ} contains only one operation. We therefore decompose a MQGM m by assigning it the circuit Cₘ=({vₘ}, { }), where vₘ is the only operation contained in m. In some implementations, in order to decompose the circuit C_{orig}^{CZ}, we will also need to decompose all SQGMs in C_{orig}^{CZ}. We describe two methods to decompose SQGMs and describe an example method to decompose C_{orig}^{CZ}.

The first method to decompose a SGQM relies on the Euler angle decomposition (which we refer to as the axial decomposition) of a U3 gate:

$$\begin{matrix}U 3 ( θ , ϕ , λ ; j ) = Rz ( ϕ ; j ) Ry ( θ ; j ) Rz ( λ ; j ) & ( 1 ) \\ = Rz ( ϕ - η ; j ) GlobalR ( - & ( 2 ) \\ \frac{π}{2} , η ) Rz ( θ ; j ) GlobalR ( \frac{π}{2} , η ) Rz ( λ + η ; j ) . & \end{matrix}$$

The gate Ry is defined identically to Rz, but with a Pauli-Y operator; and η is an arbitrary angle.

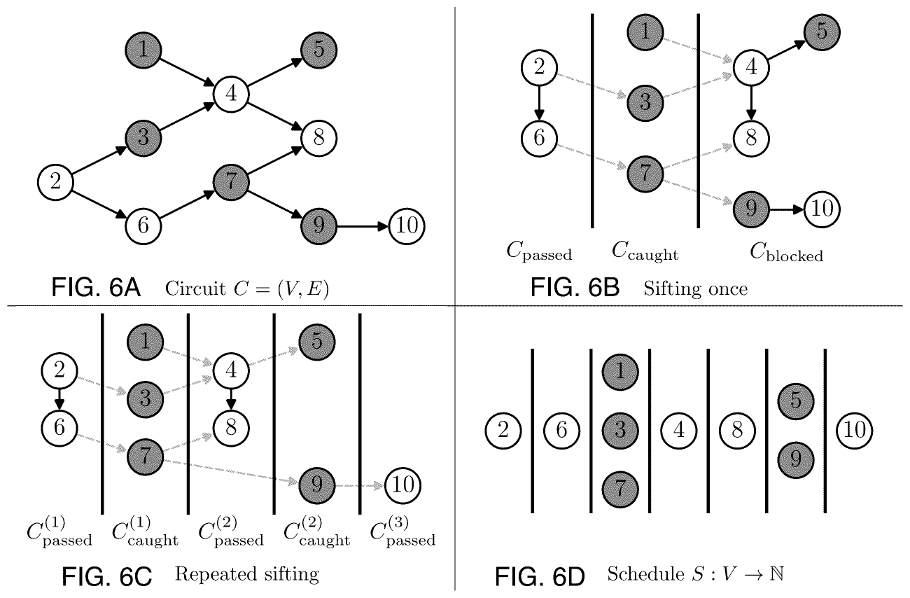

FIG. 8 shows a visual representation (read from left to right) of an axial decomposition (also known as Euler angle decomposition) of an Ry(θ; j)=U3(θ,0,0; j) gate with

$$θ = \frac{π}{3}$$

and ϕ=λ=η=0. Arrows track the orientation of vectors that initially point along the Y and Z axes.

A SGQM generally may generally contain several U3 gates that address different qubits, which is to say that the unitary operator uniquely associated with this moment can be written as ΠⱼU3(θⱼ, ϕⱼ, λⱼ; j), where θⱼ, ϕⱼ, λⱼ are angles associated with the U3 gate that addresses qubit j in the moment being decomposed, and the product over j is performed over all qubits addressed by the operations in this SQGM. The Euler angle decomposition of the SQGM is then determined by the identity

$${\prod }_{j} U 3 ( {θ}_{j} , {ϕ}_{j} , {λ}_{j} ; j ) = [ \text{} {\prod }_{j} Rz ( {ϕ}_{j} - η ; j ) ] \text{} GlobalR ( \text{} - \frac{π}{2} , \\ η ) [ \text{} {\prod }_{j} Rz ( {θ}_{j} ; j ) ] \times GlobalR ( \frac{π}{2} , η ) [ {\prod }_{j} Rz ( {λ}_{j} + η ; j ) ] . \qquad ( 3 )$$

Specifically, the result of decomposing a SQGM m using the identity in Eq. (3) is an associated circuit Cₘ. The vertices of Cₘ consist of all operations on the right hand side of Eq. (3), and the edges of Cₘ consist of all ordered pairs of operations in Cₘ that address the same qubit consecutively. That is, for any pair of operations v₁ and v₂ in the circuit Cₘ, this circuit contains the edge (v₁, v₂) if and only if there exists a qubit j for which (i) both v₁ and v₂ address qubit j, (ii) v₁ is to the right of v₂ in Eq. (3), and (iii) there are no operations between v₁ and v₂ in Eq. (3) that address qubit j.

The angle η may be chosen arbitrarily, either when constructing the circuit Cₘ or later when decomposing the circuit C_{orig}^{CZ}. In particular, this angle may be chosen to achieve some auxiliary objective. For example, this angle may be chosen to (i) reduce the number of Rz gates with nonzero angles in C_{final}, or (ii) reduce the sum of the magnitudes of the angles of Rz gates in C_{final}.

Whereas the aforementioned SQGM decomposition method relies on the Euler angle decomposition of a U3 gate, here we describe a decomposition, which we refer to as a transverse decomposition, that relies on the identity

$$\begin{matrix}U 3 ( θ , ϕ , λ ; j ) = Rz ( ϕ ; j ) Rv ( π , \frac{θ}{2} ; j ) Rz ( λ - π ; j ) & ( 4 ) \\ = Rz ( ϕ - η + \frac{π}{2} ; j ) GlobalR ( \frac{θ}{2} , η ) Rz ( π ; j ) GlobalR ( - & ( 5 ) \\ \frac{θ}{2} , η ) Rz ( λ + η - \frac{3 π}{2} ; j ) , & \end{matrix}$$

where Rv(ζ, ϑ; j)=e^{-iζV}^{ⱼ}^{(ϑ)/2} is a rotation by the angle (about the axis Vⱼ(ϑ)=cos ϑZⱼ+sin ϑXⱼ.

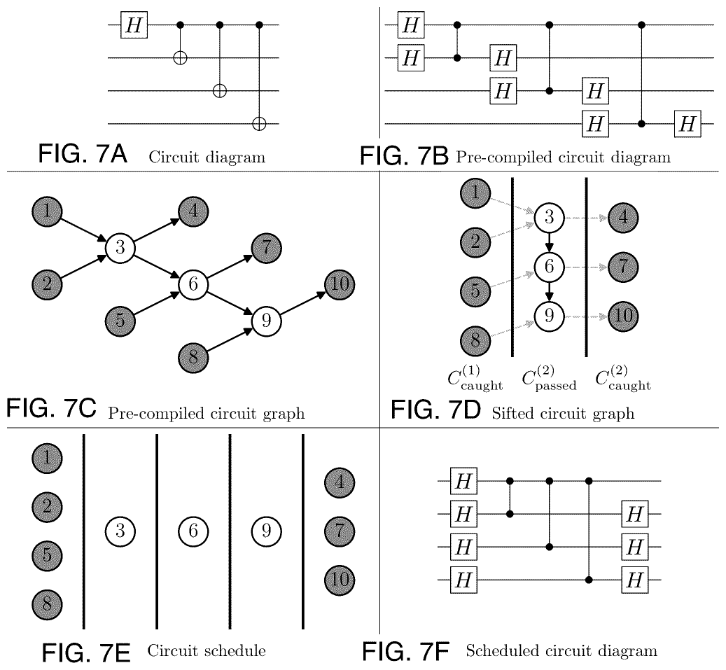

FIG. 9 shows a visual representation (read from left to right) of a transverse decomposition of an Ry(θ; j)=U3(θ,0,0; j) gate with

$$θ = \frac{π}{3} , ϕ = λ = 0 , and η = \frac{π}{2} .$$

Arrows track the orientation of vectors that initially point along the Y and Z axes.

One feature of the identity in Eq. (5) is that the total global pulse area is |θ|, which is to say the magnitudes of the first angles in the GlobalR gates on the right hand side of Eq. (5) sum to |θ|. Indeed, expanding the unitary operator associated with a SQGM in the form ΠⱼU3(θⱼ, ϕⱼ, λⱼ; j) with all |θⱼ|≤π, a global pulse area of at least maxⱼ|θⱼ| is necessary to decompose that SQGM into two GlobalR and many Rz gates. Defining θₘₐₓ=±maxⱼ|θⱼ|(with an arbitrarily chosen sign), we can solve for the Rz gate angles necessary for all qubits to recycle the same two GlobalR gates to find that

$${\prod }_{j} U 3 ( {θ}_{j} , {ϕ}_{j} , {λ}_{j} ; j ) = [ \text{} {\prod }_{j} Rz ( {ϕ}_{j} + {σ}_{j} {β}_{j} - η + \frac{π}{2} ; \\ j ) ] \text{} GlobalR ( \frac{{θ}_{max}}{2} , η ) [ \text{} {\prod }_{j} Rz ( {σ}_{j} {χ}_{j} ; j ) ] \times \text{} GlobalR ( \text{} - \frac{{θ}_{max}}{2} , \\ η ) [ \text{} {\prod }_{j} Rz ( {λ}_{j} + {σ}_{j} {α}_{j} + η - \frac{π}{2} ; j ) ] , \qquad ( 6 )$$

where each σⱼ∈{+1, −1} is an arbitrary sign, the angles

αⱼ=γⱼ+δⱼ, βⱼ=γⱼ−δⱼ, (7)

and

$${γ}_{j} = - arctan ( cos ( {θ}_{max} / 2 ) {κ}_{j} ) , \\ {δ}_{j} = - sign ( {θ}_{j} ) sign ( {θ}_{max} ) \times \frac{π}{2} , {χ}_{j} = 2 arctan ( {κ}_{j} ) , \qquad ( 8 )$$

$$where$$

$${κ}_{j} = \sqrt{\frac{{sin ( {θ}_{j} / 2 )}^{2}}{{sin ( {θ}_{max} / 2 )}^{2} - {sin ( {θ}_{j} / 2 )}^{2}}} . \qquad ( 9 )$$

Here sign(x)=x/|x|∈{+1, −1} if x≠0 and 0 otherwise; κⱼ=+∞ if θⱼ=θₘₐₓ; and arctan(x) is the inverse tangent of x. The identity in Eq. (6) can be used to decompose a SQGM using the same procedure as with identity Eq. (3). Similarly to before, the angle η, the sign of θₘₐₓ, and the signs σⱼ may be chosen arbitrarily, either when constructing the circuit Cₘ or later when decomposing the circuit C_{orig}^{CZ}. In particular, this angle may be chosen to achieve some auxiliary objective, such as minimizing the number of Rz gates in the final circuit C_{final}.

To decompose a circuit C_{orig}^{CZ} that has been scheduled, we can first decompose all of its moments, associating each moment m with a corresponding circuit Cₘ. This decomposition is unique for MGQMs, while for SQGMs we may use either of the methods from axial or transverse decomposition. Decomposing all moments of C_{orig}^{CZ} yields a sequence of circuits (C₀, C₁, C₂, . . . ), using which we construct a new sequence of circuits (C₀^{mod}, C₁^{mod}, C₂^{mod}, . . . ) according to a method described below. We then define the final circuit C_{final} as the concatenation of all circuits in the new sequence:

C_{final}=conct(C₀^{mod},C₁^{mod},C₂^{mod}, . . . ) (10)

Throughout the construction of the sequence (C₀^{mod}, C₁^{mod}, C₂^{mod}, . . . ), we keep track of an Rz “gate backlog”, simply called the “backlog” for shorthand, which assigns an angle ξⱼ to every qubit j addressed by the circuit C_{orig}^{CZ}. On a high level, the backlog keeps track of Rz gates that need to be applied to each qubit, and is used to combine these gates and apply them as late as possible. At the start of decomposition, the backlog assigns every qubit j the angle ξⱼ=0. This backlog is mutable, which is to say that the angle ξⱼ in the backlog may change throughout the construction of the sequence (C₀^{mod}, C₁^{mod}, C₂^{mod}, . . . ).

To construct the sequence (C₀^{mod}, C₁^{mod}, C₂^{mod}, . . . ), we iterate over every moment m in C_{orig}^{CZ} in increasing order. If m is a MGQM, we define Cₘ^{mod}=Cₘ. Otherwise, we can construct Cₘ^{mod} as follows:
1. Tentatively set Cₘ^{mod} to the subgraph of Cₘ that excludes the sinks in Cₘ. That is, every operation v in Cₘ is included in Cod unless v is one of the Rz gates that follows the last GlobalR gate in Cₘ.
2. Every source in Cₘ^{mod} consists of an operation of the form Rz(ψ; j) for some qubit j and angle ψⱼ. Replace this operation by Rz(ψⱼ+ξⱼ; j), where ξⱼ is the angle in the backlog associated with qubit j.
3. Every sink in Cₘ consists of an operation of the form Rz(ωⱼ; j) for some qubit j and angle ωⱼ. Replace the angle ξⱼ associated with qubit j in the backlog by the angle ωⱼ.

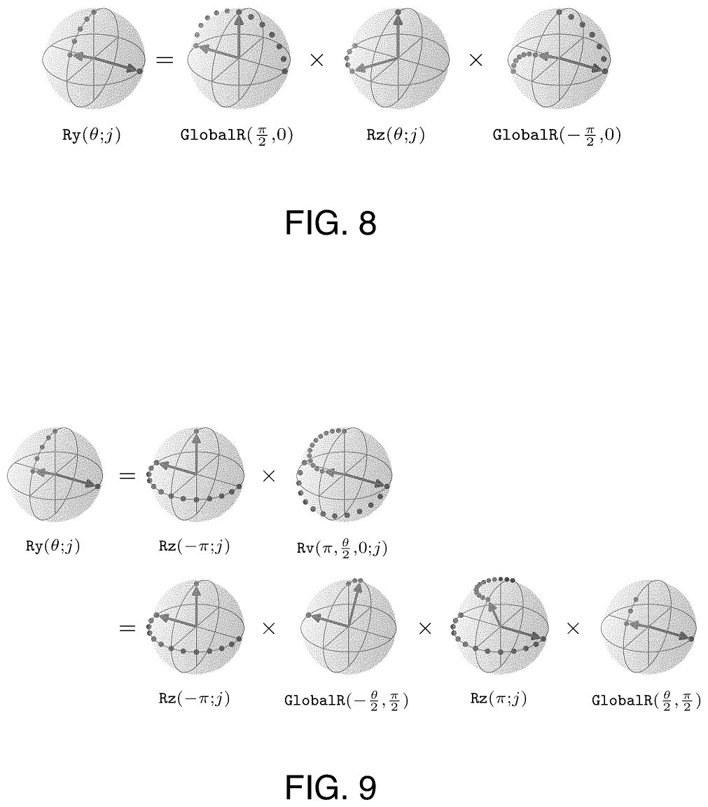

FIGS. 10A and 10B show an example of the construction of Cₘ^{mod} from Cₘ. FIG. 10A shows an Rz gate backlog and the decomposed circuit Cₘ for a SQGM that addresses two qubits in a three qubit quantum computer. FIG. 10B shows the corresponding modified circuit Cₘ^{mod}, and the backlog after constructing Cₘ^{mod}.

Once the circuits Cₘ^{mod} have been constructed for all moments m in the scheduled circuit C_{orig}^{CZ}, we can “clear out the backlog” by appending Rz gates to the circuits {Cₘ^{mod}}. Specifically, we let mₗₐₛₜ be the last moment in C_{orig}^{CZ}, and define Cₘ_{ₗₐₛₜ}+1=(V_{backlog}, { }), where V_{backlog}={Rz(ξⱼ; j): j∈bits(C_{orig}^{CZ})}, and ξⱼ is the angle associated with qubit j in the Rz gate backlog. The circuits (C₀^{mod}, C₁^{mod}, . . . , Cₘ_{ₗₐₛₜ}^{mod}, Cₘ_{ₗₐₛₜ}₊₁^{mod}) are then concatenated according to Eq. (10) to obtain the final circuit C_{final}.

The methods disclosed herein may apply to the case that an input circuit contains, in addition to unitary operations, any number of the following types of logical operations:
1. Non-unitary logical operations on any number of qubits, including measurements of any number of qubits in any basis.
2. Arbitrary logical operations on any number of classical bits.
3. Arbitrary logical operations that are in any way conditioned on classical information, which may consist of (i) any number of qubit measurements, or (ii) the state of any number of classical bits.
   In this case, the following additional considerations can be taken into account.
1. If an operation v is conditioned on classical information, and unitarily addresses only a single qubit j, then v is still treated as a single-qubit gate when scheduling and decomposing a circuit, but now the corresponding Rz gates addressing qubit j in the decomposition of the SQGM containing v get promoted to Rz gates that are conditioned on classical information in the same manner as v. Moreover, when modifying the circuit Cₘ to obtain a new circuit Cₘ^{mod}, the angle ξⱼ associated with the qubit j in the Rz gate backlog gets used and modified if and only if a unitary gets applied to qubit j.
2. Any other non-unitary operation v is transparent to the indicator function ƒ_{SQG} used for sifting, which is to say that ƒ_{SQG}(v)=0.

The methods disclosed herein can be applied to any situation in which the PartialCZ(α) gates in the Cold Atom Gate Set are replaced by any number of entangling gates that address two or more qubits. In this case, one step that can be modified in this example method for compiling circuits is that of constructing a modified circuit Cₘ^{mod} associated with a MQGM m. Specifically, the circuit Cₘ^{mod} associated with a MQGM m can now be constructed according to the following procedure:
1. Let vₘ be the (only) operation contained in m, and define the circuit Cₘ^{op}=({vₘ }, { }).
2. Let zⱼ=Rz(ξⱼ; j), where ξⱼ is the angle associated with qubit j in the Rz gate backlog, and let Jₘ be the set of all qubits j for which zⱼ does not commute with vₘ, which is to say that Jₘ={j: zⱼvₘ≠vₘzⱼ}. Define the circuit Cₘ^{z}=({zⱼ: j∈Jₘ},{ }).
3. Define Cₘ^{mod}=concat(Cₘ^{z}, Cₘ^{op}).
4. For every qubit j∈Jₘ, set the associated angle ξⱼ in the Rz gate backlog to zero.

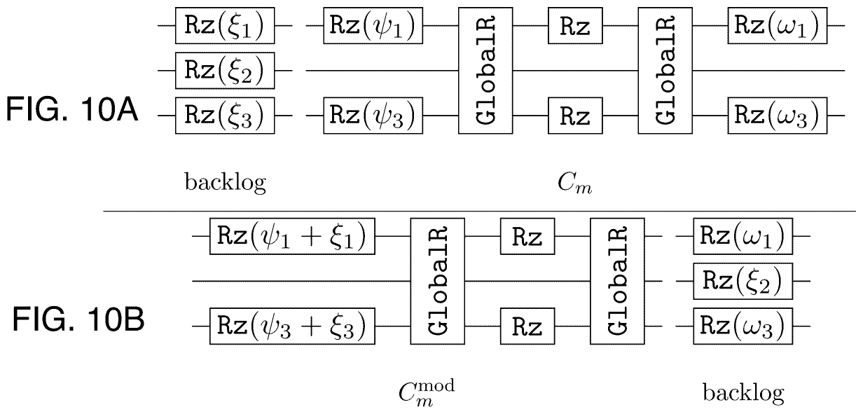

FIG. 11 shows a flowchart of a procedure 1100 for compiling a program specification. The program specification comprises at least one quantum circuit associated with both a set of quantum operations and a first schedule for the set of quantum operations. The procedure 1100 includes assigning (1102) each quantum operation in the set of quantum operations to a first passed set, a first caught set, or a first blocked set. The assigning (1102) is based at least in part on one or more of the first schedule, types of the quantum operations, or qubits addressed by the quantum operations. The first blocked set includes a first quantum operation that addresses one or more qubits that are addressed by at least one quantum operation in the first caught set. The procedure 1100 further includes determining (1104) a first passed set ordering based at least in part on one or both of the first schedule or the qubits addressed by the quantum operations. The procedure 1100 further includes determining (1106) a first caught set ordering based at least in part on one or both of the first schedule or the qubits addressed by the quantum operations. The procedure 1100 further includes determining a second schedule for the set of quantum operations, the determining comprising assigning (1108) the quantum operations in the first caught set to be performed after the quantum operations in the first passed set, and assigning (1110) the quantum operations in the first blocked set to be performed after the quantum operations in the first caught set.

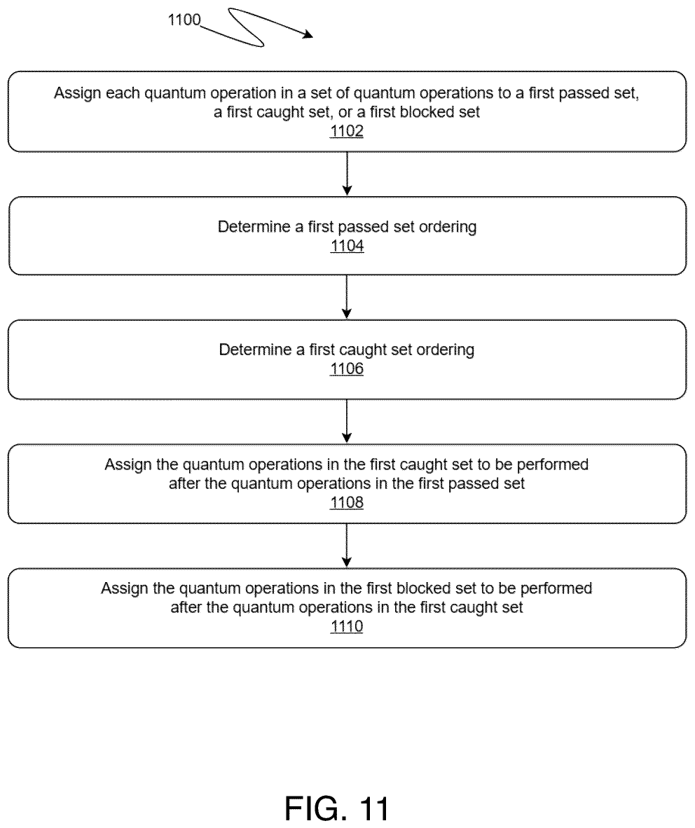

FIG. 12 shows a flowchart of a procedure 1200 for compiling a program specification. The procedure 1200 includes receiving (1202) the program specification that includes at least one quantum circuit specifying a first set of quantum operations. The procedure 1200 further includes generating a compiled program specification, wherein the compiled program specification performs the same computational task as the received program specification. The generating comprises calculating (1204) a respective set of quantum operations and a respective set of rotation angles for each quantum operation in the first set of quantum operations, and determining (1206) at least one global quantum operation and at least one inverse of the global quantum operation. The calculating (1204) is based at least in part on the first set of quantum operations, the global quantum operation, and the inverse of the global operation.

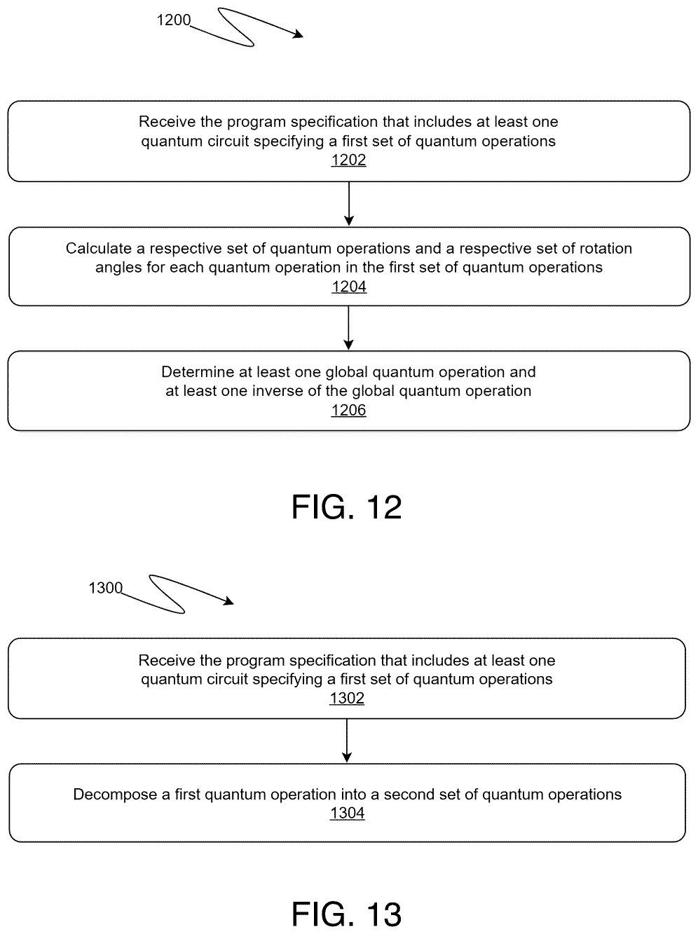

FIG. 13 shows a flowchart of a procedure 1300 for compiling a program specification. The procedure 1300 includes receiving (1302) the program specification that includes at least one quantum circuit specifying a first set of quantum operations, the first set of quantum operations comprising a first quantum operation. The procedure 1300 further includes decomposing (1304) the first quantum operation into a second set of quantum operations, the second set of quantum operations comprising one or more single-qubit quantum operations, a first global quantum operation, and an inverse of the first global quantum operation. In the second set of quantum operations, the first global quantum operation and the inverse of the first global operation each perform a quantum rotation with angles of rotation that are approximately equal in magnitude and that are each less than pi/2 radians in magnitude.

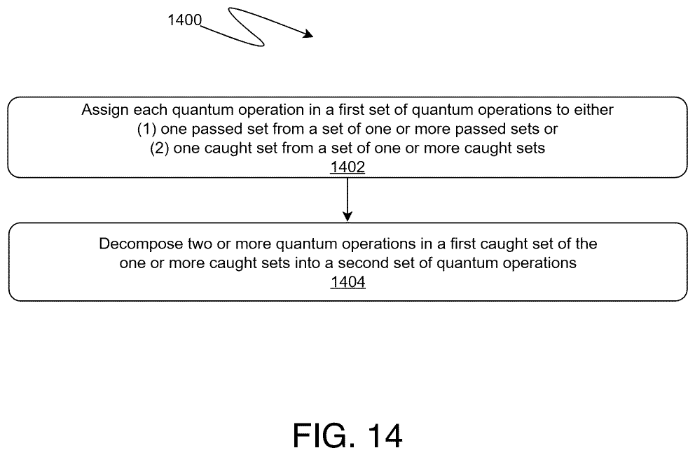

FIG. 14 shows a flowchart of a procedure 1400 for compiling a program specification. The program specification comprises at least one quantum circuit associated with both a first set of quantum operations and a first schedule for the first set of quantum operations. The procedure 1400 includes assigning (1402) each quantum operation in the first set of quantum operations to either (1) one passed set from a set of one or more passed sets or (2) one caught set from a set of one or more caught sets. The assigning (1402) is based at least in part on one or more of the first schedule, types of the quantum operations, or qubits addressed by the quantum operations. The procedure 1400 further includes decomposing (1404) two or more quantum operations in a first caught set of the one or more caught sets into a second set of quantum operations. The second set of quantum operations comprises one or more single-qubit quantum operations, a first global quantum operation, and an inverse of the first global quantum operation.

The techniques described above can be implemented using software for execution on a computer system. For example, the software can define procedures in one or more computer programs that execute on one or more programmed or programmable computer systems (e.g., desktop, distributed, client/server computer systems) each including at least one processor, at least one data storage system (e.g., including volatile and non-volatile memory and/or storage elements), at least one input device (e.g., keyboard and mouse) or port, and at least one output device (e.g., monitor) or port. The software may form one or more modules of a larger program.

The software may be provided on a non-transitory medium such as a computer-readable storage medium (e.g., solid state memory or media, or magnetic or optical media) readable by a general or special purpose programmable computer system, or delivered over a communication medium (e.g., encoded in a propagated signal) such as network to a computer system where it is stored in a non-transitory medium and executed. Each such computer program can be used to configure and operate the computer system when the non-transitory medium is read by the computer system to perform the procedures of the software.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A method for compiling a program specification that comprises at least one quantum circuit associated with both a set of quantum operations and a first schedule for the set of quantum operations, the method comprising:
assigning each quantum operation in the set of quantum operations to a first passed set, a first caught set, or a first blocked set, based at least in part on one or more of the first schedule, types of the quantum operations, or qubits addressed by the quantum operations, wherein the first blocked set includes a first quantum operation that addresses one or more qubits that are addressed by at least one quantum operation in the first caught set;
determining a first passed set ordering based at least in part on one or both of the first schedule or the qubits addressed by the quantum operations;
determining a first caught set ordering based at least in part on one or both of the first schedule or the qubits addressed by the quantum operations; and
determining a second schedule for the set of quantum operations, the determining comprising:
assigning the quantum operations in the first caught set to be performed after the quantum operations in the first passed set, and
assigning the quantum operations in the first blocked set to be performed after the quantum operations in the first caught set.

2. The method of claim 1, further comprising:
assigning each quantum operation in the first blocked set to a second passed set, a second caught set, or a second blocked set, based at least in part on one or more of the first schedule, types of the quantum operations, or qubits addressed by the quantum operations, where the second blocked set includes at least one quantum operation that addresses one or more qubits that are addressed by at least one quantum operation in the second caught set.

3. The method of claim 2, further comprising:
determining a second passed set ordering based at least in part on one or both of the first schedule or the qubits addressed by the quantum operations, and
determining a second caught set ordering based at least in part on one or both of the first schedule or the qubits addressed by the quantum operations.

4. The method of claim 3, wherein each quantum operation in the second caught set is a unitary single-qubit quantum operation.

5. The method of claim 3, wherein each quantum operation in the second passed set is a multi-qubit quantum operation that operates on two or more qubits.

6. The method of claim 2, wherein the determining of the second schedule for the set of quantum operations further comprises:
assigning the quantum operations in the second caught set to be performed after the quantum operations in the second passed set, and
assigning the quantum operations in the second blocked set to be performed after the quantum operations in the second caught set.

7. The method of claim 1, wherein the first blocked set comprises a plurality of quantum operations, and each remaining quantum operation other than the first quantum operation in the first blocked set addresses one or more qubits that are addressed by at least one quantum operation in the first caught set or the first blocked set other than that remaining quantum operation.

8. The method of claim 1, further comprising generating a first graph-based representation based at least in part on the program specification.

9. The method of claim 8, wherein the first graph-based representation is a directed acyclic graph.

10. The method of claim 1, further comprising generating respective graph-based representations for the first passed set, the first caught set, and the first blocked set.

11. The method of claim 10, wherein the respective graph-based representation associated with the first caught set contains no edges.

12. The method of claim 1, wherein each quantum operation in the first caught set is a unitary single-qubit quantum operation.

13. The method of claim 1, wherein each quantum operation in the first passed set is a multi-qubit quantum operation that operates on two or more qubits.

14. The method of claim 1, wherein the set of quantum operations comprises non-unitary quantum operations.

15. The method of claim 1, wherein the quantum circuit is associated with binary information.

16. The method of claim 15, wherein at least a portion of the binary information is associated with outcomes from qubit measurements.

17. The method of claim 15, wherein one or more of the quantum operations in the set of quantum operations depends on the binary information.

18. The method of claim 17, wherein the first caught set comprises one or more unitary single-qubit quantum operations that depend on the binary information.

19. The method of claim 17, wherein the first passed set comprises one or more non-unitary quantum operations that depend on the binary information.

20. The method of claim 1, wherein the at least one quantum circuit is associated with classical operations.

21. A method for compiling a program specification, the method comprising:
receiving the program specification that includes at least one quantum circuit associated with a first set of quantum operations; and
generating a compiled program specification, wherein the compiled program specification performs the same computational task as the received program specification, the generating comprising:
calculating a respective set of quantum operations and a respective set of rotation angles for each quantum operation in the first set of quantum operations, and
determining at least one global quantum operation and at least one inverse of the global quantum operation,
wherein the calculating is based at least in part on the first set of quantum operations, the global quantum operation, and the inverse of the global operation.

22. The method of claim 21, wherein the determining further comprises:
combining a first quantum operation and a second quantum operation in a second set of quantum operations within the set of quantum operations calculated for each quantum operation in the first set of quantum operations, the first quantum operation and the second quantum operation each comprising at least one angle of rotation about an axis common to the first and second quantum operations, into one or more quantum operations in a third set of quantum operations, the combining comprising geometrically adding the angles of rotation of the first and second quantum operations about the common axis to calculate a combined angle of rotation.

23. The method of claim 22, wherein the third set of quantum operations contains fewer quantum operations than the second set of quantum operations.

24. The method of claim 22, wherein at least one global quantum operation and at least one inverse of the global quantum operation are scheduled to execute between the execution of the first quantum operation and the second quantum operation in the second set of quantum operations.

25. The method of claim 21, wherein a magnitude of an angle of rotation of the first global quantum operation is equal to half of an angle of rotation specified by a quantum operation in the received program specification.

26. The method of claim 21, wherein the at least one quantum circuit is associated with a second set of quantum operations.

27. The method of claim 26, further comprising calculating a respective set of quantum operations and a respective set of rotation angles for each quantum operation in the second set of quantum operations.

28. The method of claim 27, wherein the calculated set of quantum operations for each quantum operation in the second set of quantum operations comprises at least one of the quantum operations in the second set of quantum operations.

29. The method of claim 26, wherein the calculated set of quantum operations for each quantum operation in the second set of quantum operations comprises a second global quantum operation and an inverse of the second global quantum operation.

30. The method of claim 29, wherein the second global quantum operation and the inverse of the second global quantum operation each perform a quantum rotation with angles of rotation that are approximately equal in magnitude and that are each less than pi/2 radians in magnitude.

31. The method of claim 21, wherein the calculated set of rotation angles for two or more of the quantum operations in the first set of quantum operations are calculated to reduce the total number of quantum operations performed.

32. The method of claim 21, wherein the calculated set of rotation angles for two or more of the quantum operation in the first set of quantum operations are calculated to reduce the sum of the magnitudes of the rotations performed by the single-qubit quantum operations.

33. The method of claim 21, wherein the at least one quantum circuit is associated with binary information.

34. The method of claim 33, wherein at least a portion of the binary information is associated with outcomes from measurements of one or more qubits associated with the at least one quantum circuit.

35. The method of claim 33, wherein one or more of the quantum operations in the first set of quantum operations depends on the binary information.

36. The method of claim 21, wherein the at least one quantum circuit is associated with classical operations.

37. A method for compiling a program specification, the method comprising:
receiving the program specification that includes at least one quantum circuit associated with a first set of quantum operations, the first set of quantum operations comprising a first quantum operation; and
decomposing the first quantum operation into a second set of quantum operations, the second set of quantum operations comprising one or more single-qubit quantum operations, a first global quantum operation, and an inverse of the first global quantum operation;
wherein the first global quantum operation and the inverse of the first global operation each perform a quantum rotation with angles of rotation that are approximately equal in magnitude and that are each less than pi/2 radians in magnitude.

38. The method of claim 37, wherein the magnitude of the angle of rotation of the first global quantum operation is equal to half of an angle of rotation specified by the first quantum operation.

39. The method of claim 37, wherein a second quantum operation in the first set of quantum operations is decomposed into a third set of quantum operations, the third set of quantum operations comprising a second global quantum operation and an inverse of the second global quantum operation.

40. The method of claim 39, wherein the second global quantum operation and the inverse of the second global quantum operation each perform a quantum rotation with angles of rotation that are approximately equal in magnitude and that are each less than pi/2 radians in magnitude.

41. The method of claim 37, further comprising choosing a set of angles used as parameters for the one or more single-qubit quantum operations.

42. The method of claim 41, wherein the set of angles are chosen to reduce the total number of quantum operations performed.

43. The method of claim 41, wherein the set of angles are chosen to reduce the sum of the magnitudes of the rotations performed by the single-qubit quantum operations.

44. The method of claim 37, wherein the determining further comprises:
combining a third quantum operation and a fourth quantum operation in a fourth set of quantum operations, the third quantum operation and the fourth quantum operation each comprising at least one angle of rotation about an axis common to the third and fourth quantum operations, into one or more quantum operations in a fifth set of quantum operations, the combining comprising geometrically adding the angles of rotation of the third and fourth quantum operations about the common axis to calculate a combined angle of rotation.

45. The method of claim 44, wherein the fifth set of quantum operations contains fewer quantum operations than the fourth set of quantum operations.

46. The method of claim 44, wherein at least one global quantum operation and at least one inverse of the global quantum operation are scheduled to execute between the execution of the third quantum operation and the fourth quantum operation.

47. The method of claim 37, wherein the at least one quantum circuit is associated with binary information.

48. The method of claim 47, wherein at least a portion of the binary information is associated with outcomes from qubit measurements.

49. The method of claim 47, wherein one or more of the quantum operations in the first set of quantum operations depends on the binary information.

50. A method for compiling a program specification that comprises at least one quantum circuit associated with both a first set of quantum operations and a first schedule for the first set of quantum operations, the method comprising:
assigning each quantum operation in the first set of quantum operations to either (1) one passed set from a set of one or more passed sets or (2) one caught set from a set of one or more caught sets, based at least in part on one or more of the first schedule, types of the quantum operations, or qubits addressed by the quantum operations; and
decomposing two or more quantum operations in a first caught set of the one or more caught sets into a second set of quantum operations, the second set of quantum operations comprising one or more single-qubit quantum operations, a first global quantum operation, and an inverse of the first global quantum operation.

51. The method of claim 50, further comprising, after the assigning, determining a second schedule for the first set of quantum operations.

52. The method of claim 51, wherein determining the second schedule comprises:
determining a first passed set ordering based at least in part on one or both of the first schedule or the qubits addressed by the first set of quantum operations, and
determining a first caught set ordering based at least in part on one or both of the first schedule or the qubits addressed by the first set of quantum operations.

53. The method of claim 51, wherein determining the second schedule comprises:
assigning quantum operations in the first caught set to be performed after quantum operations in a first passed set, and
assigning quantum operations in a second passed set to be performed after quantum operations in the first caught set.

54. The method of claim 50, wherein each quantum operation in the one or more caught sets is a single-qubit quantum operation.

55. The method of claim 50, wherein each quantum operation in the one or more passed sets is a multi-qubit quantum operation that operates on two or more qubits.

56. The method of claim 50, further comprising decomposing two or more quantum operations in a second caught set of the one or more caught sets into a third set of quantum operations, the third set of quantum operations comprising one or more single-qubit quantum operations, a second global quantum operation, and an inverse of the second global quantum operation.

57. The method of claim 56, further comprising determining a third schedule comprising the first set of quantum operations, the second set of quantum operations, and the third set of quantum operations, excluding quantum operations that were decomposed into the second set of quantum operations or that were decomposed into the third set of quantum operations.

58. The method of claim 50, further comprising generating a first graph-based representation based at least in part on the program specification.

59. The method of claim 58, wherein the first graph-based representation is a directed acyclic graph.

60. The method of claim 51, further comprising generating respective graph-based representations for at least one of the one or more passed sets and at least one of the one or more caught sets.

61. The method of claim 60, wherein the respective graph-based representation associated at least one of the one or more caught sets contains no edges.

62. The method of claim 50, wherein the first set of quantum operations comprises non-unitary quantum operations.

63. The method of claim 50, wherein the at least one quantum circuit is associated with binary information.

64. The method of claim 63, wherein at least a portion of the binary information is associated with outcomes from qubit measurements.

65. The method of claim 63, wherein one or more of the quantum operations in the first set of quantum operations depends on the binary information.

66. The method of claim 63, wherein at least of the one or more caught sets comprise one or more unitary single-qubit quantum operations that depend on the binary information.

67. The method of claim 63, wherein the at least one of the one or more passed sets comprise one or more non-unitary quantum operations that depend on the binary information.

68. The method of claim 50, wherein the at least one quantum circuit is associated with classical operations.

69. An apparatus for compiling a program specification, the apparatus comprising:
a digital computer comprising at least one central processing unit, the digital computer configured to:
process information based on at least one quantum circuit associated with both a first set of quantum operations and a first schedule for the first set of quantum operations, and
provide a compiled quantum program;
memory storing the compiled quantum program;
a quantum computer comprising a plurality of quantum processing elements associated with respective quantum states, and configured to apply coupling and transformation operations to a plurality of the quantum states according to the compiled quantum program;
where the processing comprises:
assigning each quantum operation in the first set of quantum operations to either (1) one passed set from a set of one or more passed sets or (2) one caught set from a set of one or more caught sets, based at least in part on one or more of the first schedule, types of the quantum operations, or qubits addressed by the quantum operations, and
decomposing two or more quantum operations in a first caught set of the one or more caught sets into a second set of quantum operations, the second set of quantum operations comprising one or more single-qubit quantum operations, a first global quantum operation, and an inverse of the first global quantum operation.

70. The apparatus of claim 69, wherein each quantum operation in the caught sets is a unitary single-qubit quantum operation.

71. The apparatus of claim 69, wherein each quantum operation in the passed sets is a multi-qubit quantum operation that operates on two or more qubits.

72. The apparatus of claim 69, wherein the plurality of quantum processing elements are neutral atoms or trapped ions.

73. The apparatus of claim 69, wherein the quantum computer further comprises a microwave source configured to perform the first global quantum operation and the inverse of the first global quantum operation.

74. The apparatus of claim 69, wherein the quantum computer further comprises a laser source configured to perform the one or more single-qubit quantum operations.

75. The apparatus of claim 69, wherein the first global quantum operation and the inverse of the first global operation each perform a quantum rotation with angles of rotation that are approximately equal in magnitude and that are each less than pi/2 radians in magnitude.

76. The apparatus of claim 69, wherein the quantum circuit is associated with classical operations.
